(19) United States
(12) Patent Application Publication
(10) Pub. No.: US 2018/0301039 A1
(43) Pub. Date: Oct. 18, 2018

(54) METHOD AND DEVICE FOR INDEPENDENTLY CAPTURING FLIGHT INFORMATION AND TRANSMITTING AN ADS-B SIGNAL

(71) Applicants: Ruben Leon, Oviedo, FL (US); Ananda leon, Oviedo, FL (US)

(72) Inventors: Ruben Leon, Oviedo, FL (US); Ananda leon, Oviedo, FL (US)

(21) Appl. No.: 15/914,616

(22) Filed: Mar. 7, 2018

Related U.S. Application Data
(60) Provisional application No. 62/486,758, filed on Apr. 18, 2017.

(51) Int. Cl. G08G 5/00; G01C 23/00; B64D 43/00

(52) U.S. Cl. CPC G08G 5/0004; B64D 43/00; G01C 23/00

(57) ABSTRACT

A device for independently capturing flight information and transmitting an ADS-B signal includes an aerodynamically-shaped main body having a mounting unit for being secured onto an exterior portion of an aircraft. A sensor suite is positioned within the main body to capture flight data information. An ADS-B datalink is in communication with the sensor suite for transmitting the captured flight data information, and a control unit is positioned within the main body to control an operation of the sensor suite and datalink.

### CROSS-REFERENCE TO RELATED APPLICATIONS

This application claims the benefit of U.S. Application Ser. No. 62/486,758 filed on Apr. 18, 2017, the contents of which are incorporated herein by reference.

### TECHNICAL FIELD

The present invention relates generally to aircraft flight information systems, and more particularly to an external ADS-B pod for transmitting flight data information.

### BACKGROUND

The statements in this section merely provide background information related to the present disclosure and may not constitute prior art.

The Federal Aviation Administration has outlined new regulations mandating that beginning in January 2020, aircraft must be equipped with Automatic Dependent Surveillance-Broadcast (ADS-B) out to fly in most controlled airspace. These regulations are codified in 14 CFR 91.225 and 14 CFR 91.227, and are referred to generically as the FAA's next-gen update.

The ADS-B system transmits an equipped aircraft's location, flight number and flight characteristics (e.g., speed, altitude, orientation, and changes thereto) to air traffic control systems, to provide real-time traffic information for flight controllers. The system is designed to improve efficiency in flight routing, and to prevent mid-air collisions.

To this end, most available ADS-B systems require a plurality of specific components to be installed within the cockpit of an aircraft. Each of these systems are interconnected with other cockpit systems to obtain the necessary ADS-B flight information. Unfortunately, many existing aircraft avionics suites have one or more components that are not be compatible with the new ADS-B system. In such cases, aircraft owners must replace portions of their existing avionics instruments, along with purchasing the ADS-B system itself, in order to become compliant. These expenses are increased exponentially when dealing with certified equipment.

One product has been developed which utilizes a radio receiver to capture wireless transmissions from the aircraft's transponder, extract the ADS-B information from the transmission, and then transmit the extracted information by a separate ADS-B datalink. Unfortunately, such a system relies on being able to accurately detect, translate and rebroadcast a specific wireless transmission during flight, which can easily be lost or affected by the myriad of electrical signals emanating from the aircraft itself, and other aircraft nearby. As such, there is a significant risk that such a wireless system will be unable to accurately receive and transmit the crucial ADS-B information repeatedly and reliably over time. Owing to the critical nature of this information, even one failed transmission could cause an accident and loss of life.

In addition to the above, such a system relies on the assumption that the aircraft has an avionics suite that is capable of providing all of the necessary ADS-B information to the system for detection and broadcast. Unfortunately, many sport, ultralight and other small privately-owned aircraft do not have such advanced avionics, and will be unable to utilize such a system.

With the above factors in mind, the inventors of the present invention have developed a novel approach for ensuring aircraft compliance with the above noted regulations in a manner that eliminates the drawbacks described above. The use and operation of the present invention will become more apparent in the description which follows, particularly when read in conjunction with the accompanying drawings.

### SUMMARY OF THE INVENTION

The present invention is directed to a device for independently capturing flight information and transmitting an ADS-B signal. One embodiment of the present invention can include a main body having a shape and size that is suitable for being mounted along an exterior portion of an aircraft. The main body can include a sensor suite for independently capturing flight data information, an ADS-B datalink for transmitting the flight data information, and a control unit for controlling the sensor suite and datalink.

In one embodiment of the present invention the sensor suite can be directly coupled to the aircrafts transponder to receive and decode transponder information for re-broadcast by the ADS-B datalink.

Another embodiment of the present invention can include a user interface for controlling an operation of the device during flight.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of the external ADS-B pod that is useful for understanding the inventive concepts disclosed herein.

FIG. 2 is a simplified block diagram of the sensor suite of the external ADS-B pod, in accordance with one embodiment of the invention.

FIG. 3 is a simplified block diagram of the control unit of the external ADS-B pod, in accordance with one embodiment of the invention.

FIG. 4 is a partial cutout side view of the external ADS-B pod, in accordance with one embodiment of the invention.

FIG. 5 is a perspective view of the external ADS-B pod in operation, in accordance with one embodiment of the invention.

### DETAILED DESCRIPTION OF THE INVENTION

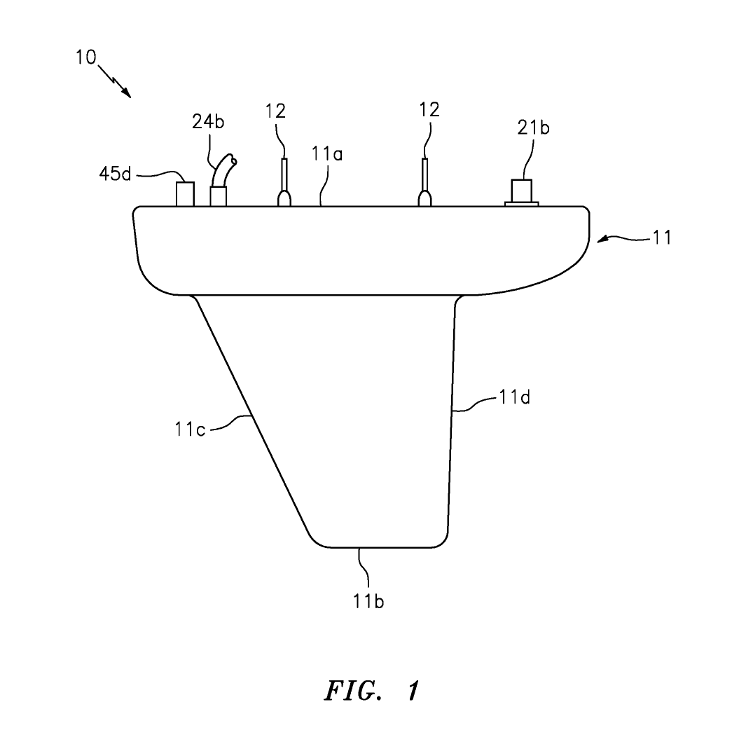

FIGS. 1-5 illustrate one embodiment of a method and device 10 for independently capturing flight information and transmitting an ADS-B signal, that are useful for understanding the inventive concepts disclosed herein. The device also being referred to hereinafter as an external ADS-B pod 10. As will be shown and described below, the external ADS-B pod is designed to provide aircraft owners with a low-cost alternative to the traditional in-cockpit ADS-B systems. To this end, the below described pod can function to independently capture flight data information and transmit the same to ground controllers via an integrated Automatic Dependent Surveillance-Broadcast (ADS-B) transmitter. As such, the pod 10 can provide all of the necessary components to make an aircraft ADS-B compliant in a single compact unit that can be removably secured to the exterior of any type of aircraft, and without affecting the certification of the same.

Although described as including a specific shape, size, number and/or type of components, this is for illustrative purposes only. As such, it is to be understood that the specific structural and functional details disclosed herein are not to be interpreted as limiting, but merely as a basis for understanding the inventive concepts, and as a representative basis for teaching one skilled in the art to variously employ the inventive arrangements in virtually any appropriately detailed structure.

While the specification concludes with claims defining the features of the invention that are regarded as novel, it is believed that the invention will be better understood from a consideration of the description in conjunction with the drawings. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As described herein, the ADS-B pod 10 can include a main body 11 that houses a sensor suite 20, a control unit 30, and an ADS-B out transmitter 41.

As shown in FIG. 1, the main body 11 can preferably include an aerodynamic blade-shaped member having a top end 11a, a bottom end 11b, a leading edge 11c, and a trailing edge 11d, each defining a generally hollow and waterproof interior space that houses the sensor suite 20 and control unit 30 described below.

The main body will preferably be installed on the belly of an aircraft, so as to always be provided with a clear transmission path to ground towers. As such, the main body can include any number of attachment fittings 12 along the top end 11a. The attachment fittings can be used in conjunction with hardware such as nuts and bolts, for example, to mount the device 10 onto the body of the aircraft. Although not illustrated, an optional mounting bracket may be provided, and can include the above described fasteners for securing the top end of the mounting bracket to the aircraft. The mounting bracket can also include any number of quick connect fittings for securing the main body 11 to the bracket in a removable manner. Such a feature allows a user to easily attach and remove the device 10 from an aircraft at any time and for any reason. Such a feature can also allow a single device 10 to be utilized with multiple aircraft. The fittings and mounting bracket being referred to as a “mounting unit” hereinafter.

In either instance, the main body can be constructed from any number of different materials such as various plastics, composite materials and/or metals, for example, that do not interfere with the operation of the below described sensor suite, and that are suitable for prolonged exposure to airborne conditions such as high winds, rain, snow and ice, for example. Of course, the main body is not limited to the illustrated blade shape, as other shapes and sizes are also contemplated.

As noted above, the ADS-B pod 10 is designed to independently and continuously capture, store, and transmit aircraft flight data information to ADS-B ground stations. This data includes, but is not limited to the real-time airspeed, altitude, identification code and location of the aircraft to which the pod is secured. As such, the pod 10 functions to independently capture such information using an integrated sensor suite 20.

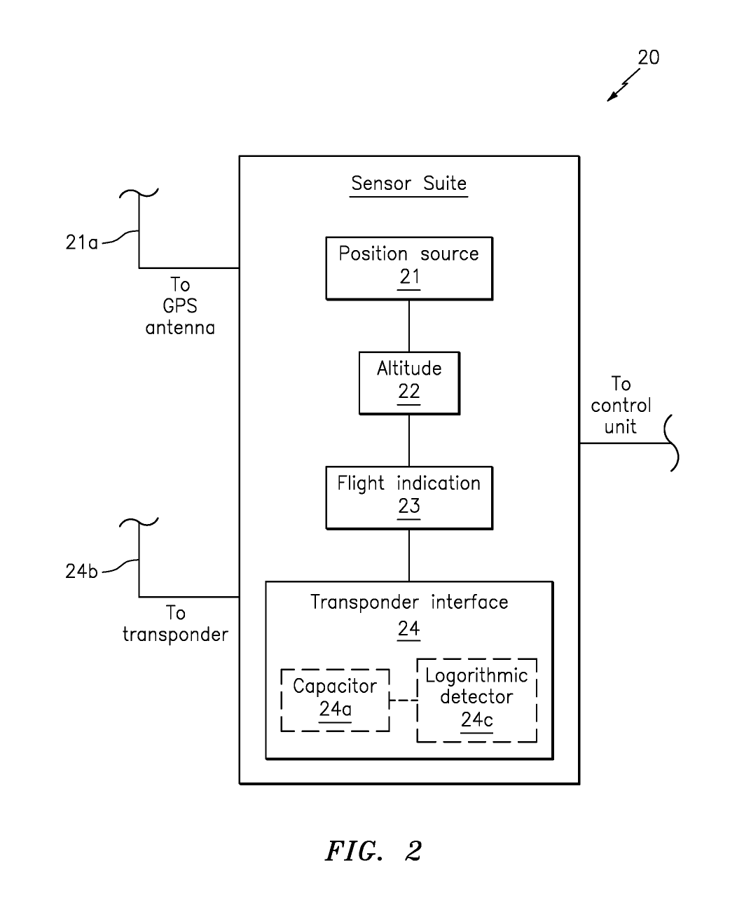

As described herein, the ADS-B pod 10 can include any number of individual sensors and/or sensor systems referred to collectively as a sensor suite 20. FIG. 2 is a simplistic block diagram illustrating an exemplary sensor suite that is suitable for capturing flight data information for transmission via the ADS-B out transmitter. As shown, the sensor suite 20 can include a position source unit 21; an altitude determination unit 22; a flight indication sensor 23; and a transponder interface unit 24, for example.

The position source unit 21 can include any number of different components for capturing location information utilizing one or more satellites. To this end, the unit 21 can include any number of components for independently accessing one or more satnav systems such as the Global Positioning System (GPS), Galileo, Beidou, WAAS, and/or GLONASS, for example. The use and operation of satellite navigation systems are well known in the art, and typically requires a signal antenna and one or more processing modules to receive and determine time and location information. As such, the position source unit 21 can be communicatively linked 21a to a plug 21b for receiving the connector of a GPS antenna that will preferably be located along the top end of the aircraft body, in order to receive the satellite signals.

Although described as including all necessary components for independently accessing a satellite system, other embodiments are contemplated wherein the position source unit 21 includes, comprises or consists of functionality for connecting directly to an onboard satnav system of the aircraft (if equipped), so as to receive the necessary location information from the aircraft itself.

The altitude determination unit 22 can include any number of instruments capable of independently determining the altitude of the aircraft to which the pod 10 is secured. Several nonlimiting examples can include various barometric sensors and pressure transducers, for example.

Per FAA requirements, ADS-B out systems need to send information about whether the aircraft is flying or on the ground (e.g., taxiing to or from a runway). As such, the flight indication sensor 23 can preferably include a distance sensor, such as a photoelectric sensor, a laser sensor, a microwave sensor and/or an ultrasonic sensor, for example, that can be oriented toward the ground. In this regard, when the distance sensor reports that the distance between the pod 10 and the ground is greater than a predetermined threshold (e.g., 10 feet, for example) the control unit can report that the aircraft is airborne. Conversely, when the sensor 23 reports that the distance between the pod 10 and the ground is less than the predetermined threshold, the control unit can report that the aircraft is on the ground.

Of course, any number of other sensors are contemplated for determining if the aircraft is in flight. Several nonlimiting examples include dedicated altimeters, speed gauges, and other types of distance sensors for example.

The transponder interface unit 24 functions to automatically receive and/or determine the transponder codes being transmitted by the aircraft. In order to specifically eliminate wireless signal interference, the transponder interface unit 24 is preferably directly coupled to the aircraft's transponder itself, in order to detect and relay the transponder codes and altitudes codes to the control unit 30. In one embodiment, the transponder interface unit can include an isolation capacitor 24a that is connected 24b to the DC power line of the aircraft's transponder, and a logarithmic detector 24c that is in communication with the control unit 30. As will be described below, the capacitor and logarithmic detector function to decode the RF signals embedded within the DC power line to determine the transponder and altitude codes being transmitted by the aircraft.

As is known to those of skill in the art, when an aircraft's transponder transmits a signal, some of the power of the transmission is absorbed by the DC power supply of the transponder itself. Therefore, by measuring the AC voltage that is imparted onto the DC power line by the transmission of the transponder, it is possible to read the transmission itself. Accordingly, the isolation capacitor can include a 1.5 pF capacitor, for example, that is in direct communication with the DC power line of the transponder. The use of this capacitor allows only higher frequencies to pass through to the logarithmic detector, which accurately converts an RF signal at its input to an equivalent decibel-scaled value at its DC output, which can be supplied directly to the CPU 31 of the below described control unit 30. One suitable example of a logarithmic detector includes the AD8313 Logarithmic detector/controller that is commercially available from Analog Devices, INC., however other such components are also contemplated.

Because the transponder puts out a very powerful signal, the transponder code and altitude can be easily distinguished and isolated using software stored within the memory 32. As other frequencies are not as powerful as the transponder frequency, these low-level signals can be filtered out. In order to ensure proper operation, the pod 10 can be initially calibrated with the transmitter in active operation (e.g., transmitting squawk codes). Software calibration can be performed to measure the power level of the transmitter signals and compensate if necessary. During flight, the CPU 31 measures the power at the pre-calibrated level, and using time, determines the validity of the signals. The valid signal is then compared to other parameters, such as the pressure altitude from the altitude determination unit 22, measured using a MEMS pressure sensor which functions as a digital output barometer. The values are compared to differentiate between transponder codes and altitudes codes and filter them accordingly. Once filtered, this information is included with the additional flight information and is then transmitted via the ADS-B transmitter 41, as described below.

Although described above as including specific sensors 21-24, this is for illustrative purposes only, as those of skill in the art will recognize that any number of different sensors can be utilized to capture any type of flight data information. Accordingly, the sensor suite is not limited to the type, arrangement and/or number of individual sensors described above. For example, other embodiments are contemplated wherein the transponder indication unit includes, comprises or consists of other types of connections between the pod 10 and the aircraft radio system that can enable the pod to read the transponder codes for broadcast via the ADS-B antenna.

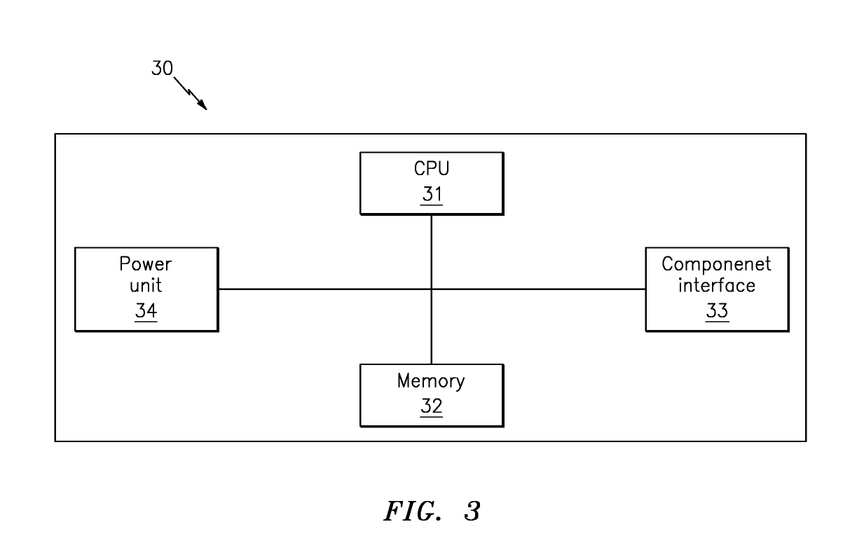

FIG. 3 is a simplistic block diagram illustrating one embodiment of the control unit 30, which can control an operation of the sensor suite 20, and the ADS-B transmitter 41. As shown, the control unit can include a processing unit 31 that is conventionally connected to an internal memory 32, a component interface unit 33, and a power unit 34.

Although illustrated as separate elements, those of skill in the art will recognize that one or more system components 31-34 may comprise, or include one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the described functionality can be provided in place of, or in conjunction with the described elements.

The processing unit 31 can include one or more central processing units (CPU) or any other type of device, or multiple devices, capable of manipulating or processing information such as program code stored in the memory 32 in order to allow the device to perform the functionality described herein.

Memory 32 can act to store operating instructions in the form of program code for the processing unit 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example.

The bulk storage device can contain any number of different programs that permit the processor to perform the functionality described herein, such as controlling the operation of the sensor suite 20 to receive and store the flight data information, and for decoding and differentiating transponder codes and altitudes codes, as described above. Additionally, memory 32 can also include one or more cache memories that provide temporary storage of at least some program code in order to reduce the number of times program code must be retrieved from the bulk storage device during execution. Each of these devices is well known in the art.

The component interface unit 33 can function to provide a communicative link between the processing unit 31 and various system elements such as the individual sensors of the sensor suite 20, the ADS-B out transmitter 41, and/or the user interface 45, for example. In this regard, the component interface unit can include any number of different components such as one or more PIC microcontrollers, standard bus, internal bus, connection cables, and/or associated hardware such as USB cables and connectors, and other such hardware capable of linking the various components. Of course, any other means for providing the two-way communication between various system components can also be utilized herein.

The power unit 34 can include any number of different components capable of receiving power from the aircraft and providing the necessary power requirements to each component of the device 10. To this end, the power unit can include any number of power cables, transformers and other such components. In one embodiment, the power unit can also include one or more batteries capable of providing emergency power for the device components in the event of aircraft power failure. Such a system can advantageously allow the pilot to notify ground controllers of an emergency situation.

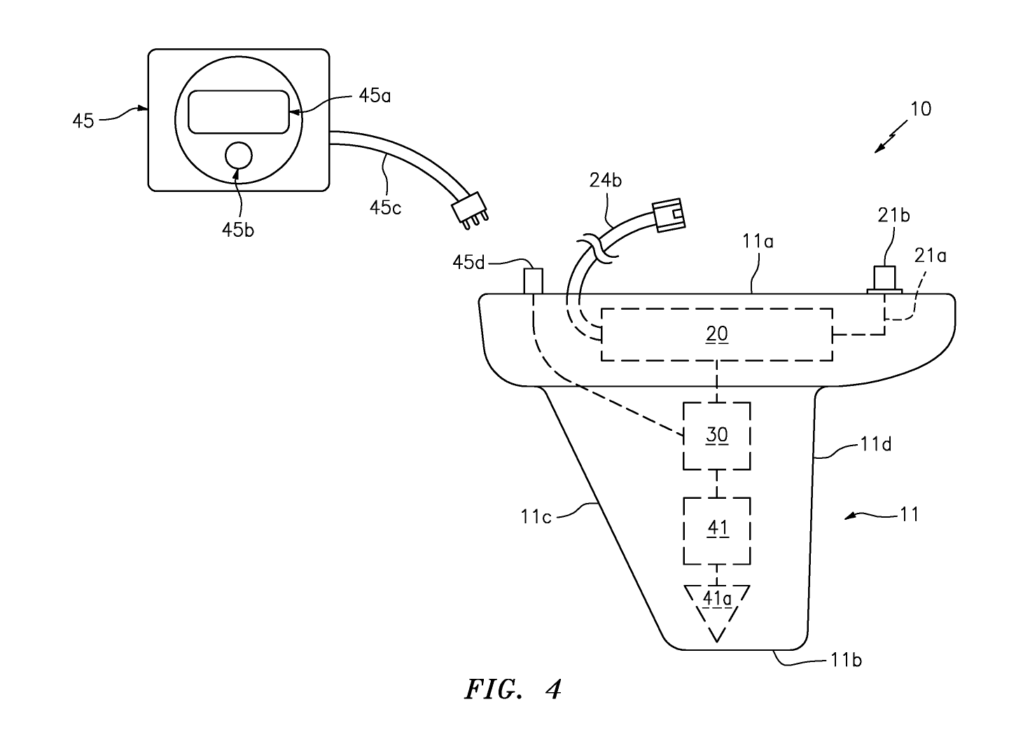

As shown best in FIG. 4, the pod 10 can include an ADS-B out transmitter/datalink 41 that can selectively and/or continuously transmit flight data information to air traffic control systems, to provide real-time traffic information for flight controllers. The transmitter 41 can be communicatively linked to the control unit 30, and can include a signal amplifier and antenna 41a that is preferably located within the main body 11 along the bottom end 11b.

The pod 10 can also include a user interface 45 having any number of physical components capable of sending and/or receiving information with the control unit 30. In the preferred embodiment, the user interface can include a display 45a having one or more buttons/switches 45b. The user interface 45 will preferably be positioned within the cockpit of the aircraft so as to be accessible by the pilot during flight, and can include a communication cable 45c that can be plugged into a corresponding receptacle 45d on the main body 11.

The user interface allows a user to selectively operate different programmatic functions of the system 10, such as switching the device between an ON and OFF operating state, and calibrating the transponder interface unit, for example. Of course, the user interface is not limited to the illustrated components, as any number of other devices capable of sending and/or receiving information between a device user and the control unit in either a wired or wireless manner are contemplated. Such devices may be located anywhere within the aircraft itself and/or directly on the main body 11.

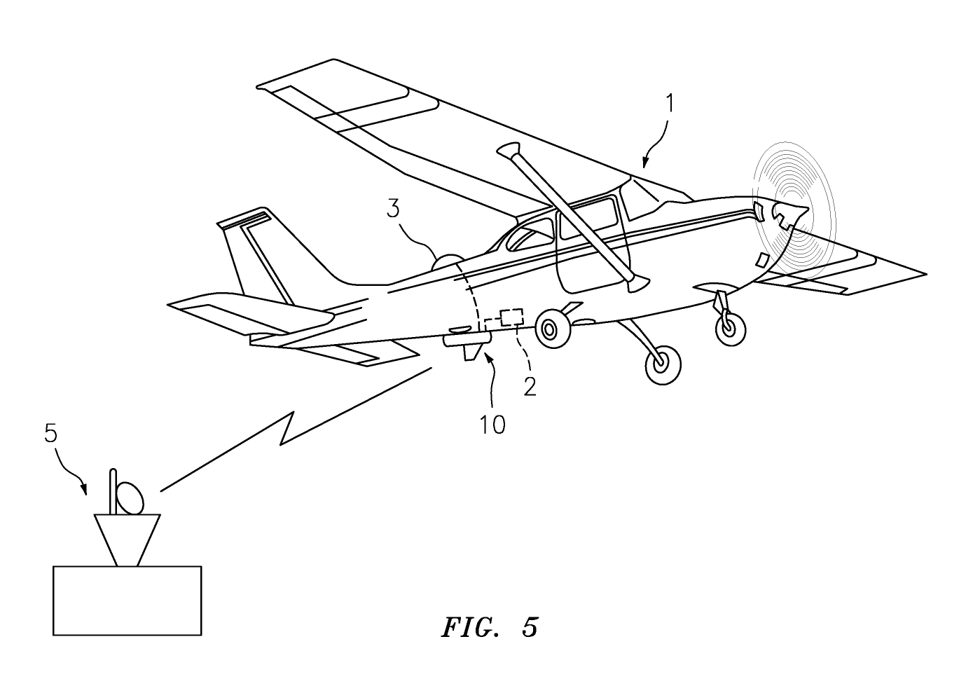

FIG. 5 illustrates one embodiment of the external ADS-B pod 10 in operation. As shown, the main body 11 can be secured onto the belly of an aircraft 1 via the hardware 12 described above. Next, the device can be connected to the onboard transponder 2 and satnav antenna 3. Once connected, the sensor suite 20 can capture flight data information that can be sent to the ADS-B transmitter 41 which can transmit the information to ground controllers 5 and other aircraft.

As described herein, one or more elements of the external ADS-B pod 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A device for independently capturing flight information and transmitting an ADS-B signal, said device comprising:
an aerodynamically-shaped main body having a plurality of sides that define a waterproof interior space;
a mounting unit that is configured to secure the main body onto an exterior portion of an aircraft in either a permanent or removable manner;
a sensor suite positioned within the main body, said sensor suite being configured to capture flight data information;
a control unit that is positioned within the main body, said control unit functioning to control an operation of the sensor suite; and
an ADS-B datalink that is in communication with the control unit and is configured to transmit the captured flight data information.

2. The device of claim 1, wherein the flight data information includes each of an airspeed, an altitude, an identification code, and a location of the aircraft to which the main body is secured.

3. The device of claim 1, wherein the sensor suite includes a position source unit that is configured to independently capture location information from a satellite.

4. The device of claim 1, wherein the sensor suite includes a position source unit that is configured to receive location information from a satnav system of the aircraft.

5. The device of claim 1, wherein the sensor suite includes an altitude determination unit that is configured to independently determine an altitude of the aircraft to which the main body is secured.

6. The device of claim 5, wherein the altitude determination unit comprises, at least one of a barometric sensor and a pressure transducer that is located within the main body.

7. The device of claim 1, wherein the sensor suite includes a flight indication sensor that is configured to independently determine whether the aircraft to which the main body is secured is in flight.

8. The device of claim 1, wherein the flight indication sensor comprises:
a distance measuring sensor that is positioned within the main body.

9. The device of claim 1, wherein the sensor suite includes a transponder interface unit that is configured to receive a transponder code from a transponder of the aircraft to which the main body is secured.

10. The device of claim 9, wherein the transponder interface unit is further configured to receive an altitude code from the transponder.

11. The device of claim 1, wherein the control unit further includes:
a memory for storing the flight data information.

12. The device of claim 1, wherein the ADS-B datalink is configured to continuously transmit the flight data information.

13. The device of claim 1, wherein the ADS-B datalink is configured to selectively transmit the flight data information.

14. The device of claim 1, further comprising:
a user interface that is in communication with the control unit.

15. A method for independently capturing flight information and transmitting an ADS-B signal, said method comprising:
providing an aerodynamically-shaped main body that is configured to be secured onto an exterior portion of an aircraft;
independently capturing, via a sensor suite located within the main body, flight data information; and
transmitting, via an ADS-B datalink located within the main body, the flight data information.

16. The method of claim 15, wherein the flight data information includes each of an airspeed, an altitude, an identification code, and a location of the aircraft to which the main body is secured.
